(19) United States
(12) Patent Application Publication
(10) Pub. No.: US 2003/0205890 A1
(43) Pub. Date: Nov. 6, 2003

(54) Air bag containment apparatus

(75) Inventors: Joseph J. Davis JR., Ortonville, MI (US); John H. Faarup, Rochester Hills, MI (US)

Correspondence Address: BROOKS & KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI

(21) Appl. No.: 10/139,453

(22) Filed: May 6, 2002

(51) Int. Cl. B60R 21/16

(52) U.S. Cl. 280/732

(57) ABSTRACT

An air bag apparatus for use in a vehicle instrument panel is provided. The air bag apparatus is located on the passenger's side of the vehicle, and includes a canister integrally molded into the instrument panel. The canister has an opening and is configured to receive an air bag module which attaches to the canister. The canister is covered by a door that is precisely located to cover the opening in the canister. Because the canister is integrally molded into the instrument panel, assembly and installation of a separate canister is eliminated. This reduces production time, reduces the complexity of assembly, and lowers overall vehicle production costs.

### BACKGROUND OF THE INVENTION

1. Field of the Invention

The present invention relates to an air bag apparatus for containing an air bag in a vehicle.

2. Background Art

The use of passenger side air bags in vehicles is well known. Typically, an air bag container is attached to an instrument panel on the passenger's side of the vehicle. An air bag and an air bag inflator are placed inside the container, and a door covers the opening to the container and presents a generally flush surface that attempts to match the surface of the instrument panel. Passenger air bag containers can be made from a number of materials, including extruded metals such as aluminum, and molded polymers. Regardless of the material used, or the method of manufacture, passenger side air bag containers are separate from the instrument panel. This means that the container must be installed and attached to the instrument panel in a separate assembly operation. This increases the production time, the complexity of assembly, and the production costs of a vehicle.

Accordingly, it is desirable to provide a passenger side air bag containment apparatus that overcomes the short comings of prior art passenger side air bag containers by eliminating the need to install the air bag container in a separate operation, thereby reducing the time of production, the complexity of assembly, and the overall production costs of a vehicle.

### SUMMARY OF THE INVENTION

The present invention provides an air bag apparatus for use in the passenger's side of a vehicle that is integrally molded into the vehicle instrument panel, thereby eliminating the need for a separate air bag container installation operation.

Another aspect of the invention provides an air bag apparatus integrally molded into the passenger's side of a vehicle instrument panel that reduces the complexity of the vehicle assembly.

A further aspect of the invention provides an integrally molded passenger side air bag apparatus that reduces the overall production costs of a vehicle.

Accordingly, an air bag apparatus for use in a vehicle instrument panel is provided that comprises a canister integrally molded into the instrument panel. The canister has an opening for receiving an air bag module, which includes an air bag and an air bag inflator. The canister also defines a space for housing the air bag module. The air bag apparatus further includes a door for covering the opening of the canister. The door has an attachment device for attaching the door to the canister.

Another aspect of the invention provides an air bag apparatus for use in a vehicle instrument panel that comprises a canister integrally molded into the instrument panel that has an opening for receiving an air bag module. The canister defines a concavity for housing the air bag module. The air bag apparatus also includes a door which is attachable to the canister and configured to cover the opening in the canister.

Yet another object of the present invention provides a vehicle instrument panel including an air bag apparatus, at least a portion of which is integrally molded into the instrument panel. The air bag apparatus comprises a canister integrally molded into the instrument panel. The canister has an opening for receiving an air bag module, which includes an air bag and an inflator, and also defines a space for housing the air bag module. A door for covering the opening in a canister is also provided, having an attachment structure for attaching the door to the canister.

The above object and other objects, features, and advantages of the present invention are readily apparent from the following detailed description and best mode for carrying out the invention when taken in connection with the accompanying drawings.

### BRIEF DESCRIPTION OF THE DRAWINGS

FIG. 1 is a fragmentary side sectional view of an air bag apparatus in accordance with the present invention;

FIG. 2 is a fragmentary perspective view of the snaps and four-way locators used on the air bag door shown in FIG. 1;

FIG. 3 is a fragmentary perspective view of the instrument panel having the canister integrally molded therein, with the air bag module and door removed for clarity;

FIG. 4 is a fragmentary perspective view of a portion of a vehicle interior, illustrating a rear-facing air bag; and

FIG. 5 is a fragmentary perspective view of a portion of a vehicle interior, illustrating a vertically oriented air bag.

### DETAILED DESCRIPTION OF THE PREFERRED EMBODIMENT(S)

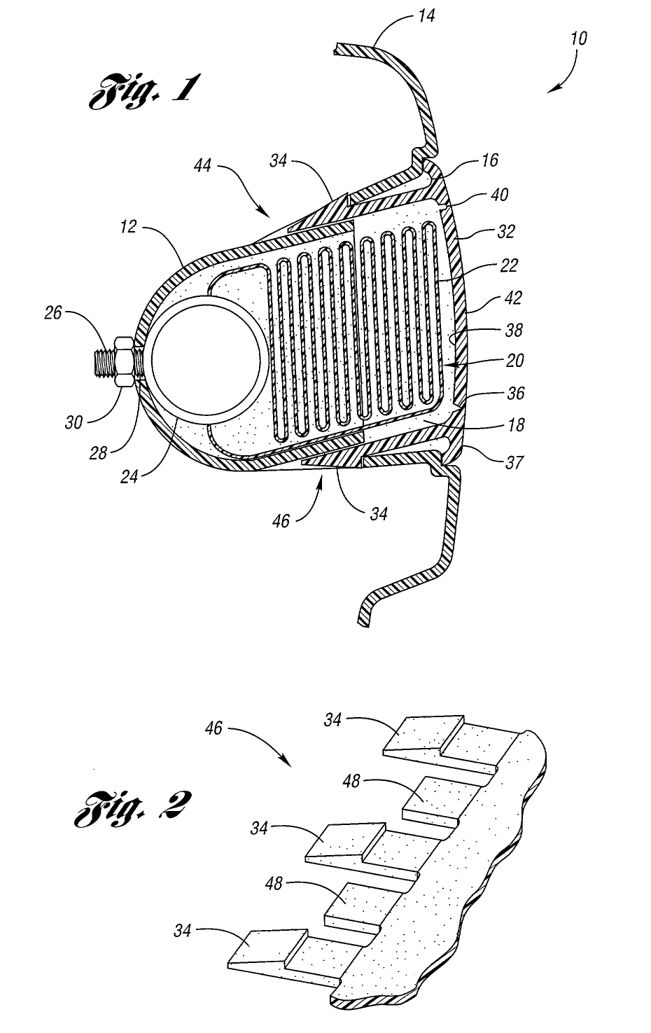

FIG. 1 shows a side sectional view of an air bag apparatus 10 in accordance with the present invention. The air bag apparatus 10 includes a canister 12 integrally molded into a vehicle instrument panel 14. The canister 12 has an opening 16 and defines a space 18 for housing an air bag module 20. The air bag module 20 includes an air bag 22 and an inflator 24. The inflator 24 has a threaded stud 26 attached to it. The threaded stud 26 protrudes through an aperture 28 in the canister 12 to receive a nut 30 to secure the air bag module 20 to the canister 12. The threaded stud 26 and the nut 30 comprise a preferred fastening device to attach the air bag module 20 to the canister 12; however, the use of other fastening devices is contemplated, and the canister 12 can be molded in such a way that it can accommodate numerous different types of fastening devices.

Covering the opening 16 of the canister 12 is a door 32 that is attached to the instrument panel 14 via snaps 34. The snaps 34 are designed to allow for easy installation of the door 32, yet at the same time securely fasten the door 32 to the instrument panel 14. The door 32 contains a notched portion 36 that is located adjacent to one edge 37 of the door 32. The notched portion 36 runs the entire width of a backside 38 of the door 32, and includes a sharp comer at its base which produces a weakened area in the door 32, and effectively creates a tear seam. When the air bag 22 is deployed, the door 32 will tear along the notched portion 36 thereby allowing the air bag 22 to fully deploy to protect the vehicle occupant. As the door 32 is opened by the deployment of the air bag 22, it rotates around a hinge 40 that is formed by a rounded groove along the backside 38 of the door 32. Neither the notched portion 36 or the hinge 40 are visible to a vehicle occupant who observes a front side 42 of the door 32.

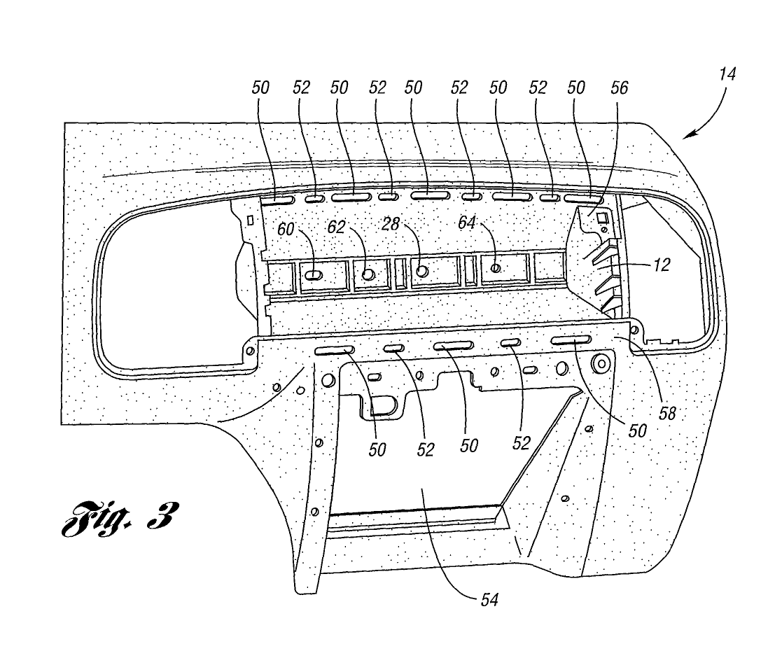

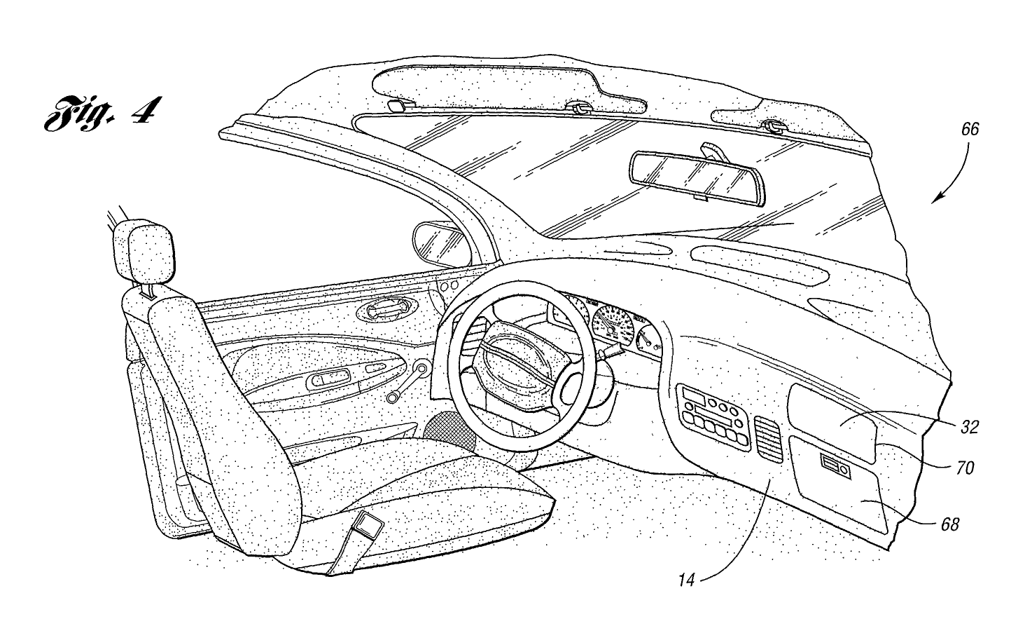

The door 32 can be made from a variety of polymeric materials, though a thermoplastic polyester elastomer such as DuPont Hytrel8 is preferred. The snaps 34 used to attach the door 32 to the instrument panel 14 extend outward from the backside 38 of the door 32. There are typically two sets of snaps 34, an upper set 44 and a lower set 46. The lower set of snaps 46 is shown in detail in FIG. 2. In this view, a pair of four-way locators 48 is shown between the snaps 34. The purpose of the four-way locators 48 is to properly align the door 32 in a side-to-side and an up-down alignment. Specifically, when the door 32 is installed in the instrument panel 14, the four-way locators 48 help to ensure that the door 32 is properly aligned in four directions. The four-way locators help improve the fit and finish of door 32 when it is attached to the instrument panel 14. The snaps 34 mate with a first set of slots 50 in the instrument panel 14, while the four-way locators mate with a second set of slots 52 adjacent to the first set of slots (see FIG. 3.)

Turning to FIG. 3, a portion of the instrument panel 14 is seen with the canister 12 molded therein, and door 32 and the air bag module 20 removed for clarity. The large opening 54 in the instrument panel 14 is configured to receive a glove box (not shown). The slots 50, 52 are located along an upper portion 56 and a lower portion 58 of the instrument panel 14. The slots 50 are configured to easily receive the snaps 34 to facilitate installation of the door 32, yet are also configured to ensure that the door 32 remains securely fastened to the instrument panel 14 upon deployment of the air bag 22. The dimensions of the slots 52, as well as their location, control the fit and finish of the door 32 when it is installed into the instrument panel 14. Alignment of the door 32 with the canister opening 16 is important for a number of reasons, including aesthetics. Proper configuration of the slots 52 helps to ensure that the door 32 is properly centered in the opening 16, and that it will not be subject to side-to-side or up-down movement after it is installed.

Also seen in FIG. 3 are a number of alternate mounting holes 60, 62, 64 adjacent to the aperture 28. The alternate mounting holes 60, 62, 64 provide flexibility for the attachment of the air bag module 20 to the canister 12, and are included in what may generally be termed module attachment devices. Although the air bag module 20 will often be attached to the canister 12 with a threaded stud that protrudes through the aperture 28, some air bag modules may require different attachments. An almost infinite number of module attachment devices can be molded into the canister 12 to facilitate attachment of a wide variety of air bag modules. This increases the flexibility and thus the utility of the air bag apparatus 10, thereby providing another advantage over prior art devices with limited air bag module attachment options.

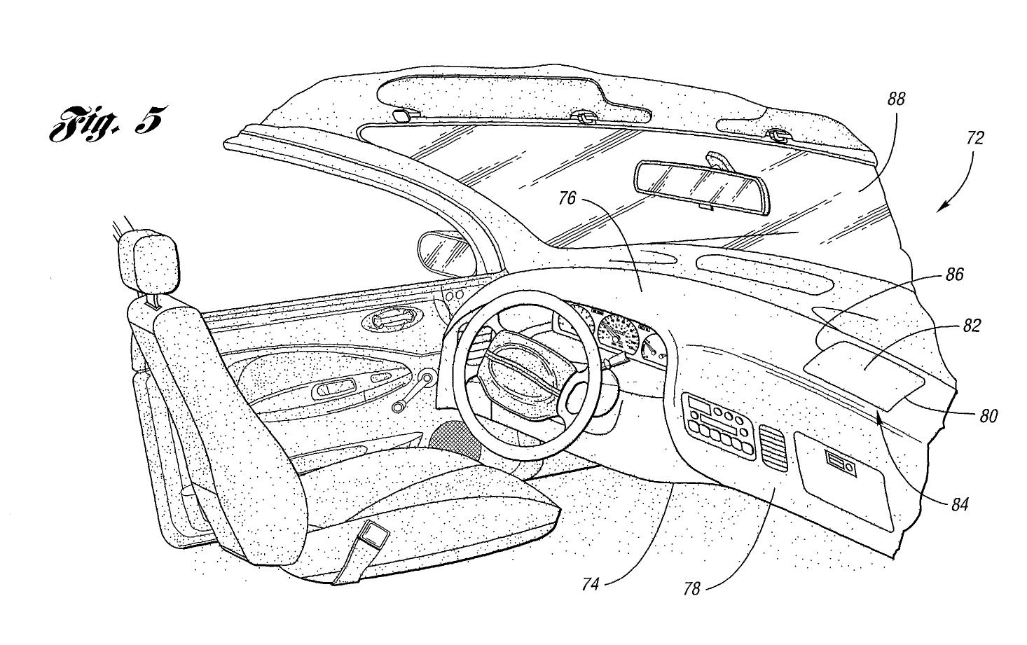

Another advantage of the present invention is that the canister can be molded into the vehicle instrument panel in different locations, thereby giving a vehicle designer more options. For example, the canister 12 shown in FIGS. 1 and 3, is configured to be a part of what is commonly termed a “rear-facing” air bag. That is, the air bag door 32 faces the rear of the vehicle, and thus deployment of the air bag 22 is initially in the direction of the passenger. FIG. 4 shows a portion of the interior of a vehicle 66 having the air bag apparatus 10 installed. The door 32, located above a glove box 68, is visible to a vehicle occupant who is facing the front of the vehicle 66. Through the use of the four-way locators 48 and their mating slots 52, the perimeter 70 of the door 32 blends smoothly into the instrument panel 14, creating an aesthetically pleasing appearance.

An alternative to a rear-facing air bag is a vertically oriented air bag, as shown in FIG. 5. The interior of a vehicle 72 has an instrument panel 74 having a top portion 76 and a front portion 78. Seen on the top portion 76 is the perimeter 80 of a door 82 used with an air bag apparatus 84 in accordance with an alternative embodiment of the present invention. In this configuration, the door 76 covers an opening 86 of a canister (not visible) integrally molded with the instrument panel 74. An air bag (also not visible) is contained within the canister such that it initially deploys upward instead of back toward the vehicle occupant. Upon contact with the windshield 88, which slopes in toward the interior of the vehicle 72, the air bag then deploys in the direction of the occupant.

The choice of whether to mold the canister into the front of an instrument panel, as in FIGS. 1, 3, and 4, or mold it into the top of the instrument panel, as in FIG. 5, depends on a number of factors. First, a vertically oriented air bag is only effective in vehicles having a prominently inward sloping windshield. For example, many trucks have windshields that have only a slight inward slope, thereby rendering them poorly suited to vertically oriented air bags. In vehicles that have a prominently inward sloping windshield, other factors such as aesthetics and possible interference with other components within the instrument panel may be considered. Thus, a number of considerations must be taken into account by a designer when making the decision of whether to orient the air bag vertically, or to have a rear-facing air bag. Regardless of the air bag orientation, the present invention with its integrally molded canister and precisely located door, is flexible enough for either configuration.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An air bag apparatus for use in a vehicle instrument panel, comprising:
a canister integrally molded into the instrument panel having an opening for receiving an air bag module and defining a space for housing the module; and
a door for covering the opening, and having a door attachment device for attaching the door to the instrument panel.

2. The air bag apparatus of claim 1, wherein the canister includes an aperture formed therethrough for receiving at least a portion of a fastening device to secure the air bag module to the canister.

3. The air bag apparatus of claim 2, wherein the fastening device includes a threaded stud attached to a portion of the air bag module.

4. The air bag apparatus of claim 1, wherein the canister includes a module attachment device for facilitating attachment of the air bag module to the canister.

5. The air bag apparatus of claim 1, wherein the door attachment device includes a plurality of snaps, and the canister includes a plurality of apertures configured to receive the snaps.

6. The air bag apparatus of claim 1, wherein the door includes at least one locating device, and the canister includes an aperture configured to receive the at least one locating device.

7. The air bag apparatus of claim 1, wherein the door includes a weakened area disposed adjacent to one edge of the door for forming a tear seam when the air bag is deployed.

8. An air bag apparatus for use in a vehicle instrument panel, comprising:
a canister integrally molded into the instrument panel having an opening for receiving an air bag module therethrough, and defining a concavity for housing the module; and
a door, attachable to the canister and configured to cover the opening.

9. The air bag apparatus of claim 8, wherein the canister includes a module attachment device for facilitating attachment of the air bag module to the canister.

10. The air bag apparatus of claim 8, wherein the canister includes an aperture formed therethrough for receiving at least a portion of a fastening device to secure the air bag module to the canister.

11. The air bag apparatus of claim 10, wherein the air bag module includes an air bag and an inflator.

12. The air bag apparatus of claim 11, wherein the fastening device includes a threaded stud attached to a portion of the air bag module.

13. The air bag apparatus of claim 8, wherein the door includes an attachment structure, and the canister is configured to receive the attachment structure to secure the door to the canister.

14. The air bag apparatus of claim 13, wherein the attachment structure includes a plurality of snaps, and the canister includes a plurality of apertures configured to receive the snaps.

15. The air bag apparatus of claim 8, wherein the door includes at least one locating device and the canister includes an aperture configured to receive the at least one locating device.

16. A vehicle instrument panel including an air bag apparatus, at least a portion of which is integrally molded therein, the air bag apparatus comprising:
a canister integrally molded into the instrument panel having an opening for receiving an air bag module, and defining a space for housing the module;
an air bag module disposed in the space and including an air bag and an inflator; and
a door for covering the opening, having an attachment structure for attaching the door to the instrument panel.

17. The vehicle instrument panel of claim 16, wherein the canister includes an aperture formed therethrough for receiving at least a portion of a fastening device to secure the air bag module to the canister.

18. The vehicle instrument panel of claim 17, wherein the fastening device includes a threaded stud attached to a portion of the air bag module.

19. The vehicle instrument panel of claim 16, wherein the attachment structure includes a plurality of snaps, and the canister includes a plurality of apertures configured to receive the snaps.

20. The vehicle instrument panel of claim 19, wherein the door includes at least one locating device and the canister includes an aperture configured to receive the at least one locating device.
